(19) United States
(12) Patent Application Publication
(10) Pub. No.: US 2013/0086207 A1
(43) Pub. Date: Apr. 4, 2013

(54) PUSH CLIENT OF MOBILE TERMINAL AND METHOD OF CHANGING PROVIDER USING THE SAME

(71) Applicant: Dae Hee LEE, Seoul (KR)

(72) Inventor: Dae Hee LEE, Seoul (KR)

(73) Assignee: LG CNS CO., LTD., Seoul (KR)

(21) Appl. No.: 13/336,057

(22) Filed: Dec. 23, 2011

(30) Foreign Application Priority Data
Sep. 29, 2011 (KR) 10-2011-0099320

(51) Int. Cl. G06F 15/16

(52) U.S. Cl. 709/217

(57) ABSTRACT

Disclosed herein are a push client of a mobile terminal and a method of changing a provider using the push client. The push client is connected to a push server via one or more providers. At least one application is installed in the push client. The push client includes a monitoring unit and a control unit. The monitoring unit monitors network status of a mobile communication network, and provides data related to the determination of a possibility of receiving push messages provided by the push server. When the possibility of reception is weak, the control unit actively selects an activated provider from among the providers based on importance of the application, thereby enabling the push messages to be received.

### TECHNICAL FIELD

The present invention relates generally to a push client of a mobile terminal and a method of changing a provider using the push client and, more particularly, to a push client of a mobile terminal and a method of changing a provider using the push client, which are capable of achieving the best reception while taking into consideration a defined priority, network status and a session with the push server.

### BACKGROUND

In general, push technology is an information transfer scheme which allows a transmission request to be initiated by a central server over the Internet. This technology is contrasted with pull technology which allows a transmission request to be initiated by a client. Push technology is also referred to as “server push.”

Push technology may be contrasted with the technology of a web browser which employs a pull technique. When using the web browsers which are currently used to navigate the Internet and which employ pull technology, users always request desired information from a server which has information, and ultimately decide that use of the web browsers and the destinations they visit.

In contrast, push technology is used to automatically provide news or desired special information, such as periodic stock market information, to users even when they do not individually request them.

The difference between the two technologies depends upon who controls the flow of information. In pull technology, users, such as consumers, can freely control the acquisition of information and contact with information, whereas in push technology, parties who transfer information, such as advertisers, can directly control the flow of information.

A representative push technology application is a mailing list. Users can use push service merely when subscribing to a website providing a mailing list and then requesting the mailing list. Push service is extending to other fields besides electronic mail. Currently, push service encompasses NetCast, news service, multimedia content, etc.

Meanwhile, news or information service is a push service which has developed in a manner different from that of NetCast. News or information service performs the functionality of collecting and creating news contents for users, unlike NetCast, and provides advanced service compared to NetCast which simply transfers information.

With the popularization of mobile communication terminals, a variety of application services using a mobile communication network have been actively provided. A representative service thereof is to transfer real-time information, such as e-mails and chats between users, to mobile communication terminals using a variety of methods. A representative of these methods is Wireless Application Protocol (WAP) push, which transfer push data via periodic communication between a base station and a mobile terminal.

With the active use of third-generation (3G) data communication and the spread of Wi-Fi (a Wireless LAN), there is widely used a method in which a client establishes a TCP/IP session with a server and data to be transferred by the server is transmitted to a mobile terminal via the TCP/IP session.

A server-client structure in which the connection is established over a network includes the functionality of registering a client as a service target of a server and initiating service provided using a protocol capable of providing both a push mode service and a pull mode service, the functionality of supporting pull mode controlled by the client, the functionality of supporting push mode controlled by the server, and the functionality of supporting remote control and termination controlled by the server.

However, since switching between the pull mode service and the push mode service cannot be controlled, the pull mode service is compulsorily terminated when the server starts to provide the push mode service while a user is working in pull mode, thereby inconveniencing the user. Accordingly, there is an urgent need for control suitable for the characteristics of an application system.

Therefore, Korean Patent No. 10-0739721 discloses a method in which a client can selectively receive a push mode service and a pull mode service using priority when push and pull mode multimedia services are provided between the server and a client which are connected over a network.

FIG. 1 is a flowchart illustrating a conventional method of providing a push mode service. As shown in FIG. 1, a push server requests a priority from a client at step S301, and the client transmits a response message to the push server at step S302. The priority can be given to pull mode or push mode. Accordingly, the priority of the client is checked at step S303. If the pull mode has a priority, switching to the pull mode is performed at step S304. In contrast, if the push mode has a priority, switching to the push mode is performed at step S305. If a user selection has a priority at step S303, the user selection is input at step S306. If it is determined that the user has selected pull mode at step S307, pull mode is performed at S308. In contrast, if it is determined that the user has selected push mode at step S307, push mode is performed at S309.

FIG. 2 is a flowchart illustrating another conventional method for providing a push mode service. As shown in FIG. 2, a push server requests and receives a priority from a client at steps S501 and S502, and determines whether to perform remote control at step S503. If pull mode has priority, remote control is terminated at step S504. Otherwise a remote control command is transferred at steps S505 and S507. If the pull mode has priority, remote control is not performed. In contrast, if push mode has priority, the results of remote control are reported to the server at step S506. Steps S508 to S510 are the same as steps S306 to S309.

However, since a mobile terminal is not fixed, the mobile terminal moves into an out-of-service area and is subjected to a change in the status of a network to the impossibility of a connection to a WiFi, 3G or 4 G communication network, with the result that application messages cannot be received because a TCP/IP session required to perform push is disconnected until an activated network is found.

Furthermore, when a user using a mobile terminal at a flat fee is moving while using a WiFi service in order to avoid being charged, the WiFi connection is dropped, and therefore important messages cannot be immediately received until the WiFi service is resumed. Moreover, since the importance of an application cannot be set by a user, messages cannot be received when it is desired, or messages must be received when it is not desired. This may result in a feeling of repulsion towards the corresponding application on behalf of the user. In a situation where a user does not want to receive messages, more specifically during overseas roaming, a connection to a 3G or 4G network is established during overseas roaming regardless of the fact that fees are charged for the simple reception of application messages, so that a large amount of fees accrue because of receipt of the messages. Therefore, a problem arises in that the user comes to have a sense of extreme repulsion towards the mobile terminal which supports automatic roaming as well as towards an application which transfers the messages to the user.

### SUMMARY

Accordingly, the present invention has been made keeping in mind the above problems occurring in the prior art, and an object of the present invention is to provide a push client of a mobile terminal and a method of changing a provider using the push client, which are capable of, when network status has been changed because of the characteristics of a mobile terminal, actively changing a provider between WiFi, 3G and 4G providers, so that the reception of application messages is not dependent upon network status, and so that the provider can be changed such that application messages can be received even when the network status becomes poor.

Another object of the present invention is to provide a push client of a mobile terminal and a method of changing a provider using the push client, which are capable of actively changing the provider so that important messages can be immediately received even in a situation where a WiFi connection is dropped while a user is moving and using a WiFi service, and which are capable of checking thoroughly whether messages can be transferred by checking a session with a push server as well as the network connection, so that messages can be accurately delivered.

Another object of the present invention is to provide a push client of a mobile terminal and a method of changing a provider using the push client, which are capable of establishing a session with a push server while taking into consideration power consumption required to create the session with the push server, whether a session connection is available, and whether a specific period has elapsed since the transmission of a final push message.

Another object of the present invention is to provide a push client of a mobile terminal and a method of changing a provider using the push client, which are capable of receiving the importance of an application from an application developer and a user, establishing a connection to the provider in conformity with the set importance, and giving priority to the importance set by the user by allowing the importance set by the user to take precedence in priority over the importance set by the developer, so that the user actively sets the reception of application messages and, therefore, the utilization of the application of the user can be maximized.

Still another object of the present invention is to provide a push client of a mobile terminal and a method of changing a provider using the push client, which are capable of changing a provider in the case where a user has not set the importance of an application and a connection to a network and a session connection has not been established such that messages can be periodically received in conformity with the levels set by the application developer, and which are capable of periodically receiving messages in conformity with levels set by the user as well as an importance set by the user.

Still another object of the present invention is to provide a push client of a mobile terminal and a method of changing a provider using the push client, which are capable of, when a user has made setting to the refusal of the reception of application messages, preventing all application messages from being received regardless of the setting of an application developer, so that a feeling of repulsion towards a corresponding application can be eliminated, and so that the use of a mobile terminal which uses the application can become more prolific.

In order to accomplish the above objects, the present invention provides a push client of a mobile terminal, the push client being connected to a push server via one or more providers and including at least one application installed therein, the push client including a monitoring unit for monitoring network status of a mobile communication network, and providing data related to a determination of a possibility of receiving push messages provided by the push server; and a control unit for, when the possibility of reception is weak, actively selecting an activated provider from among the providers based on importance of the application, thereby enabling the push messages to be received.

In order to accomplish the above objects, the present invention provides a method of changing a provider using a push client of a mobile terminal, the method including the steps of (a) when an application inside the push client is loaded, storing an ID of the application and a setting of a developer in a storage unit; (b) when a user makes a setting, the control unit searching for an available provider; and (c) if the available provider exists but a connection to a push server is impossible, the control unit extracting a list of other available providers and establishing a connection to an activated provider selected from among the other available providers.

### BRIEF DESCRIPTION OF THE DRAWINGS

These and other features of this invention will be more readily understood from the following detailed description of the various aspects of the invention taken in conjunction with the accompanying drawings in which:

FIG. 1 is a flowchart illustrating a conventional method for providing a push mode service;

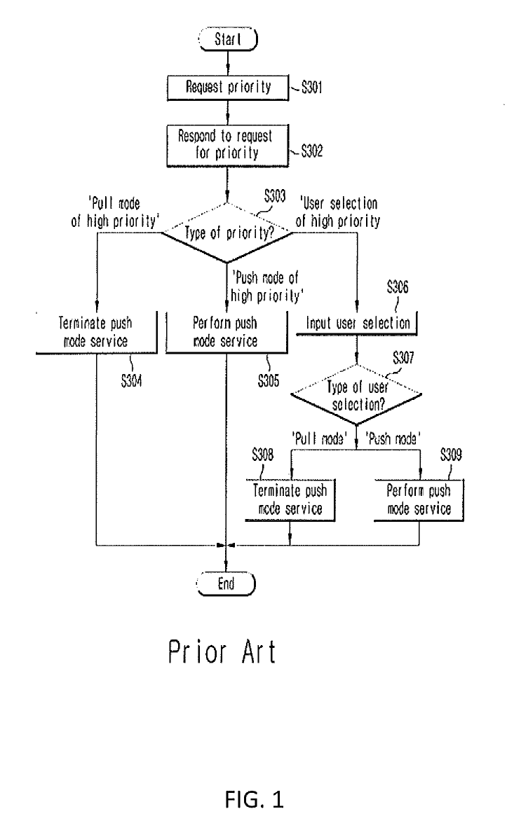

FIG. 2 is a flowchart illustrating another conventional method for providing a push mode service;

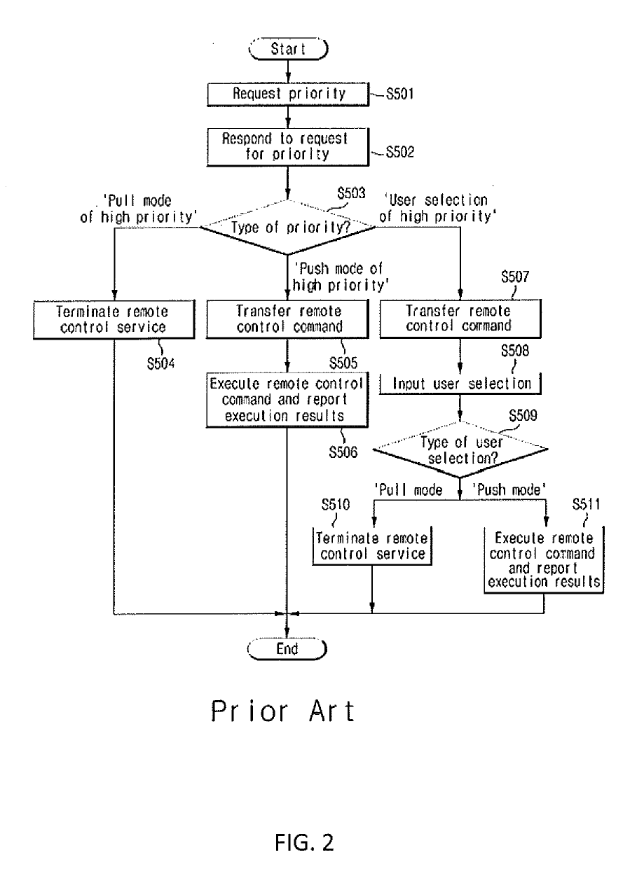

FIG. 3 is a block diagram illustrating a push client of a mobile terminal according to technology disclosed in the present application;

FIG. 4 is a flowchart illustrating a method of changing a provider using the push client of a mobile terminal according to technology disclosed in the present application;

FIG. 5 is a flowchart illustrating a method of changing a provider using the push client of a mobile terminal according to an embodiment of technology disclosed in the present application;

FIG. 6 is a flowchart illustrating a method of changing a provider using a push client of a mobile terminal according to another embodiment of technology disclosed in the present application;

FIG. 7 shows an embodiment of a screen in which a user sets importance, as in FIG. 4;

FIG. 8 shows an embodiment of a screen in which a user sets importance, as in FIG. 5;

FIG. 9 shows an embodiment of a screen in which a user sets the levels of importance, as in FIG. 8; and

FIG. 10 shows an embodiment of a screen in which a user makes setting to the refusal of reception, as in FIG. 6.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Reference now should be made to the drawings, in which the same reference numerals are used throughout the different drawings to designate the same or similar components.

Since descriptions of disclosed technology are only presented to describe embodiments which are intended to describe the structures and/or functions of the present invention, it should not be interpreted that the scope of the rights of the disclosed technology is limited by the embodiments described herein. That is, the embodiments may be modified in various ways and, therefore, it should be understood that the scope of the rights of the disclosed technology may include equivalents which can implement the technical spirit of the present invention. Furthermore, since objects or advantages presented in connection with the disclosed technology do not require that a specific embodiment should fulfill all of them or only them, it should not understood that the scope of the rights of the disclosed technology is limited by the presented objects and advantages.

Meanwhile, the meanings of terms described herein should be appreciated as follows:

The terms “first” and “second” are only used to distinguish one element from another element, and the scope of the rights of the disclosed technology should not be limited by these terms. For example, a first element may be designated as a second element, and similarly the second element may be designated as the first element.

When it is described that one element is “connected” or “coupled” to another element, the one element may be directly connected or coupled to another element, but an intervening element may exist therebetween. On the other hand, when it is described that one element is “directly connected” or “directly coupled” to another element, it should be understood that no element exists therebetween. Meanwhile, other expressions which describe the relationships between elements, that is, “between ˜” and “directly between ˜” or “adjacent to ˜” and “directly adjacent to ˜,” should be interpreted in the same way.

It should be understood that a singular expression may include a plural expression, as long as they are obviously different from each other in context. In this application, the meaning of “include” or “have” are intended to specify a property, a fixed number, a step, a process, an element, a component, and/or a combination thereof but are not intended to exclude the presence or addition of other properties, fixed numbers, steps, processes, elements, components, and/or combinations

Reference characters (for example, a, b, c, etc.) related to steps are used for convenience of description, and are not intended to describe the sequence of the steps. The steps may occur in different sequences, as long as a specific sequence is not described obviously in the context. That is, the steps may occur in a specified sequence, may occur simultaneously, or may be performed in the reverse sequence.

All the terms used herein have the same meanings as terms that are generally understood by those having ordinary knowledge in the art to which the disclosed technology pertains, as long as the terms are differently defined. It should be understood that terms defined in generally-used dictionaries have meanings coinciding with those of terms in the related technology. As long as the terms are not defined obviously in the present application, they are not ideally or excessively analyzed as formal meanings.

Embodiments according to the present application will be described in detail below with reference to the accompanying illustrative drawings.

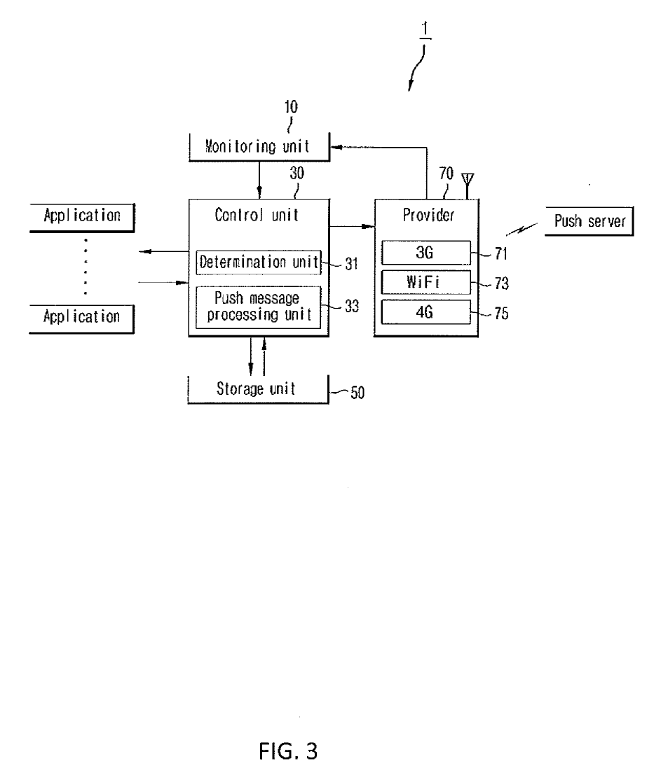

FIG. 3 is a block diagram illustrating the push client of a mobile terminal according to technology disclosed in the present application. Referring to FIG. 3, the push client 1 of a mobile terminal is installed inside the mobile terminal, and includes a monitoring unit 10, a control unit 30, a storage unit 50, and a provider 70.

The monitoring unit 10 monitors the status of the connection of the mobile terminal to a network and the status of the connection to a push server, and extracts the availability of the network, connection status, and the availability of a connection to the push server and transfers the extracted information to the control unit 30.

That is, the monitoring unit 10 is a component for monitoring the networking status of the mobile terminal, and monitors for a change in the network provider 70 and for events occurring in the network provider 70 and transfers the monitored information to the determination unit 31 of the control unit 10.

The control unit 30 includes the determination unit 31 and a push message processing unit 33. The determination unit 31 determines whether to change a connected network based on the monitoring results of the monitoring unit 10, the IDs AppIDs of applications stored in the storage unit 50, and the importance of push, requested by each of the applications, when the application was registered. The control unit 30 changes the provider 70 based on the determination results of the determination unit 31.

That is, the determination unit 31 determines whether a change of the network, that is, a change of the provider 70, is necessary by considering the importance set by a developer or a user and stored in the storage unit 50, and a network event in the provider 70 monitored by the monitoring unit 10.

When the mobile terminal receives a push message, the push message processing unit 33 analyzes the received message, checks whether an application corresponding to an application ID AppID in the message has been installed, and transfers the message to the corresponding application if the corresponding message has been installed.

The control unit 30 transfers commands to control and drive respective components, and is defined as the paths to the respective components and also as a subject component for driving the respective components.

The storage unit 50 receives and stores the importance of push, requested by each of applications which receive the push service, when the application is registered. The importance of push is stored in association with a corresponding application ID AppID.

The provider 70 is installed in the mobile terminal to enable the use of third-generation (3G) and fourth-generation (4G) mobile communication networks and the wireless Internet, such as WiFi. The provider 70 includes a 3G provider 71, a WiFi provider 73, and a 4G provider 75. The control unit 30 may select one from among the 3G provider 71, the WiFi provider 73 and the 4G provider 75 in accordance with the determination of the determination unit 31.

A user may have installed one or more applications on the mobile terminal. The applications receive and process messages which are transferred by the push server. When an application is first installed, its application ID AppID is transferred to the control unit 30. The mobile terminal acts as means for detecting the application. The control unit 30 stores the application ID AppID and the importance, set by a user or developer, in the storage unit 50.

The push server includes an application ID AppID and a mobile terminal ID in a message, and causes the message to be transferred to the corresponding mobile terminal. The push server maintains a TCP/IP connection to the mobile terminal, and transmits a message in real time via the connection.

The push client 1 of the mobile terminal attempts to connect to the push server over a mobile communication network, continuously maintains the connection so that a state in which a push message can immediately enter from the push server can be maintained, analyzes the received message, and then transfers the push message to a corresponding application based on an application ID AppID in the message, thereby enabling the message to be immediately transferred to a user.

The mobile terminal is connected to a mobile communication network, includes the push client 1 of the mobile terminal and applications installed therein, and is in a state capable of processing a push message.

The operation of the push client 1 of the mobile terminal will be described in detail below with reference to the accompanying drawings.

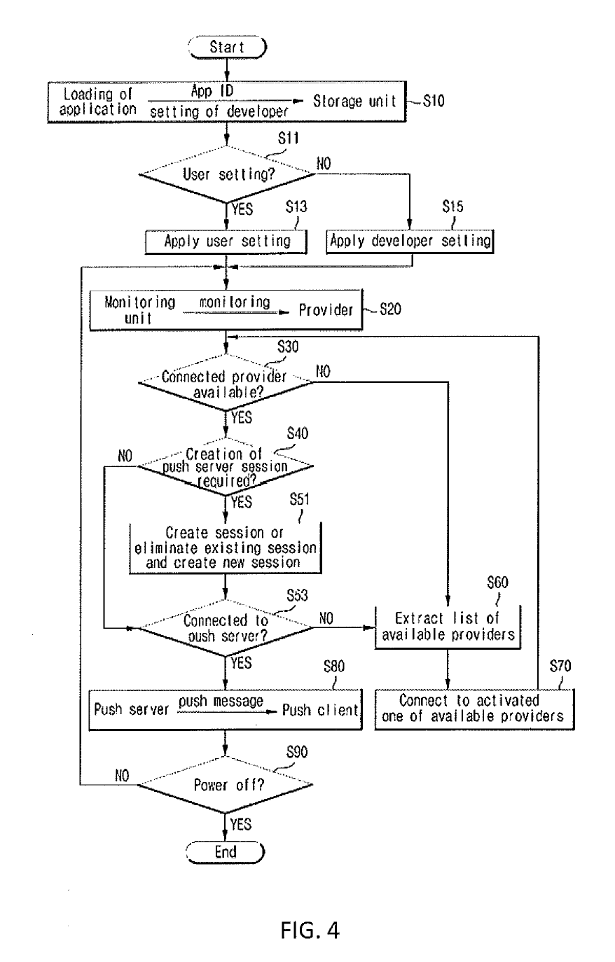

FIG. 4 is a flowchart illustrating a method of changing a provider using the push client of a mobile terminal according to technology disclosed in the present application. As shown in FIG. 4, when an application is installed in the mobile terminal by a user, the control unit detects the installation of the application, transfers information about the installation to the storage unit, and stores the ID AppID of the application and the importance of the application set by a developer or the user at step S10.

If a user performs setting even though a developer has set the importance, the setting of the user is allowed to take precedence in priority over the setting of the developer in order to enhance the authority of the user. Accordingly, it is checked whether the user has set the importance at step S11.

If the user has set the importance, the importance set by the user is used at step S13. In contrast, if the user wants to use an application without setting the importance for it, the importance set by the developer is used as a fallback at step S15.

That is, since the developer of an application usually sets the importance for his or her own reasons and a user also sets the importance for convenience's sake, the importance has always been set for the application regardless of the setting of the user. Table 1 below lists all the cases where the importance has been set for an application.

TABLE 1

| | User | Developer | Operation |
|---|---|---|---|
| Setting of | ◯ | ◯ | operation based on user |
| importance | | | setting |
| | ◯ | X | operation based on user |
| | | | setting |
| | X | ◯ | operation based on |
| | | | developer setting |
| | X | X | basic operation |

As shown in Table 2 below, if setting has been made, the monitoring unit continuously monitors the connection to the push server, and attempts to change the network provider in order to achieve the best connection even though a connection has not been established. If the setting has not been made, the monitoring unit does not continuously monitor the connection to the push server, and a basic operating mode in which separate work is not performed is entered into when a connection has not been established.

TABLE 2

| | Operation |
|---|---|
| Set (◯) | operation based on user setting |
| Not set (X) | default basic operation |

Furthermore, when a user has set the importance for any one of a plurality of applications, the set importance is used first, and an operation that is performed is identical to that of the case where setting has been performed.

Accordingly, even when the importance has been set for one of a plurality of applications installed in the user's mobile terminal, the following steps are performed on the basis of the application whose importance has been set.

That is, the application whose importance has been set should receive messages in real time. For example, when a user uses an application via the WiFi wireless Internet in a coffee house and then cannot use WiFi anymore because he or she leaves the coffee house, changing to 3G mode is performed. There is a delay time until communication can be actually performed because it is not apparent whether communication whereby messages can be actually received is taking place. Therefore, messages to be received by the application may be put in a queue until communication is actually performed, and then be received at one time once a connection to a push server has actually been established. In order to prevent this phenomenon, the technology disclosed in the present application not only changes the provider but also allows the mobile terminal to actively create a session with the push server in order to enable actual communication.

For this purpose, the monitoring unit continually monitors the connection to the provider in real time at step S20, and determines whether the connected provider is available at step S30. The criteria for the determination of the availability may include one or more of signal intensity, whether a mobile terminal has made a subscription, and, in the case of WiFi, the status of WEP or WPA authentication.

If, as a result of the determination at step S30, it is determined that the provider connected to the network is not available, the determination unit extracts a list of available providers based on information obtained by the monitoring of the monitoring unit at step S60. When the determination unit selects a connection to the activated one of the available providers at step S70, the control unit establishes the connection to the activated provider.

In this case, when there is no provider which can be selected, the process returns to step S20 until the monitoring unit can find an activated provider, and then the monitoring unit continuously performs network monitoring (not shown).

Once the selection of a network provider has been completed at step S30, it is determined whether the creation of session with a push server is necessary in order to check whether a connection to the push server is possible at step S40. A session is created, or an existing disconnected session is eliminated and then a new session is created at step S51. Thereafter, it is determined whether a connection to the push server is possible at step S53.

Unlike existing technology, the technology disclosed in the present application can not only determine whether a connection to a push server is possible for itself, but can also change a provider if a connection to a push server, which enables actual communication, is not possible.

That is, there are many cases where messages are not transferred even when a connection to a network has been established. There is no technology which can check both of whether a connection to a network has been established and whether actual communication is not possible, and which can also change a provider when necessary. The technology disclosed in the present application checks thoroughly whether a session with a push server has been established even when a connection to a network has been established, and therefore a TCP/IP-level connection can be maintained, thereby eliminating the state in which merely a connection to a network has been established but does not work and also enabling the more accurate transfer of push messages.

Furthermore, if a connection to a push server is possible at step S53, a push message is transferred from the push server to a push client at step S80. If a connection to the network has been established but access to the push server has not been gained, a list of available providers is extracted at step S60, a connection to an activated provider is established at step S70, and then it is checked whether the connected provider is available.

The criteria for the determination of the possibility of a connection at step S53 may include one or more of a network delay attributable to a shortage of bandwidth, the impossibility of the extraction of the IP of a push server attributable to the error of a Domain Name Server (DNS), packet filtering attributable to the firewall of a network provider, the temporary impossibility of a connection during transfer over a network, and the impossibility of a connection attributable to the overload or error of a push server. If a connection is impossible, available network providers are extracted, and a new session with a new activated network provider is created when the network provider is activated.

If not only a connection to a network provider but also a connection to a push server are possible and therefore a state in which communication is fully possible is maintained, a push message is transferred from the push server to the push client at step S80. The process returns to step S20 until the power is turned off at S90, and then push messages related to the application whose importance has been set are continuously transferred at S90.

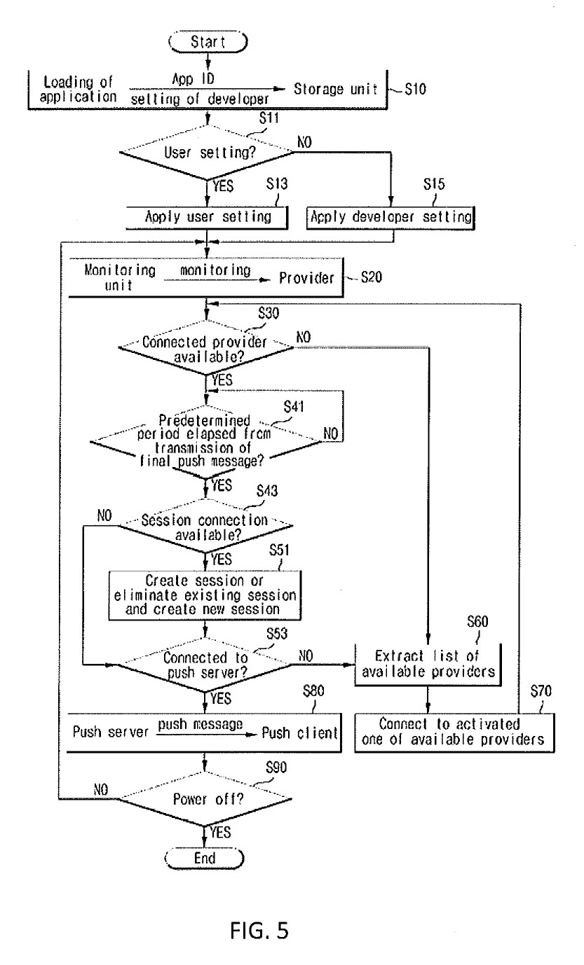

FIG. 5 is a flowchart illustrating a method of changing a provider using a push client of a mobile terminal according to an embodiment of technology disclosed in the present application. As shown in FIG. 5, when an application is installed in the mobile terminal by a user, the control unit detects the installation of the application, transfers information about the installation to the storage unit, and stores the ID AppID of the application and the importance of the application set by a developer or the user at step S10.

If a user performs setting even though a developer has set the importance, the setting of the user is allowed to take precedence in priority over the setting of the developer in order to enhance the authority of the user. Accordingly, it is checked whether the user has set the importance at step S11.

If the user has set the importance, the importance set by the user is used at step S13. In contrast, if the user wants to use an application without setting the importance for it, the importance set by the developer is used as a fallback at step S15.

That is, since the developer of an application usually sets the importance for his or her own reasons and a user also sets the importance for convenience's sake, the importance has always been set for the application regardless of the setting of the user. Table 3 below lists all the cases where the importance has been set for an application:

TABLE 3

| | User | Developer | Operation |
|---|---|---|---|
| Setting of | ◯ | ◯ | operation based on user |
| importance | | | setting |
| | ◯ | X | operation based on user |
| | | | setting |
| | X | ◯ | operation based on |
| | | | developer setting |
| | X | X | basic operation |

Furthermore, when a user has set the importance has been set for any one of a plurality of applications, the set importance is used first, and an operation that is performed is identical to that of the case where setting has been performed.

Accordingly, even when the importance has been set for one of a plurality of applications installed in the user's mobile terminal, the following steps are performed on the basis of the application whose importance has been set.

That is, the application whose importance has been set should receive messages in real time. For example, when the user uses an application via the WiFi wireless Internet in a coffee house and then cannot use WiFi anymore because he or she leaves the coffee house, changing to 3G mode is performed. There is a delay time until communication can be actually performed because it is not apparent whether communication whereby messages can be actually received is taking place. Therefore, messages to be received by the application may be put in a queue until communication is actually performed, and then be received at one time once a connection to a push server has actually been established. In order to prevent this phenomenon, the technology disclosed in the present application not only changes the provider but also allows the mobile terminal to actively create a session with the push server in order to enable actual communication.

As shown in Table 4 below, if setting has been made, the monitoring unit continuously monitors the connection to the push server, and attempts to change the network provider in order to achieve the best connection even though a connection has not been established. If setting has not been made, the monitoring unit does not continuously monitor the connection to the push server, and a basic operating mode in which separate work is not performed is entered into when a connection has not been established. If setting to the refusal of reception has been made, no operation is performed even when the network is activated.

TABLE 4

| | Operation |
|---|---|
| Set (◯) | operation based on user setting |
| Not set (X) | default basic operation |
| Set to | no operation |
| refusal of | |
| reception | |

In the method according to the present application, in order to reduce resource consumption resulting from the creation of a push session, it is checked whether the time at which a final push message was transmitted falls within a predetermined period, and a push session is not created if the time falls within the predetermined period. The reason for this is that the electricity of a battery is consumed by the creation of a session because of the characteristics of a mobile terminal.

The predetermined period is determined in conformity with a level which is set by a user. Level 1 is set for the case where messages may be checked at intervals of 6 hours because they are very unimportant, level 2 is set for the case where messages may be checked at intervals of 3 hours because they are unimportant, level 3 is set for the case where messages may be checked at intervals of 1 hour because they are normal, level 4 is set for the case where messages may be checked at intervals of 30 minutes because they are important, and level 5 is set for the case where messages may be checked at intervals of 5 minutes because they are very important.

The start and end of the period may be varied depending on the characteristics of each device and each application. It will be apparent that the levels may not be set stepwise, but may be set linearly.

For this purpose, the monitoring unit continually monitors the connection to the provider in real time at step S20, and determines whether the connected provider is available at step S30. The criteria for the determination of the availability may include one or more of signal intensity, whether a mobile terminal has made a subscription, and, in the case of WiFi, the status of WEP or WPA authentication.

If, as a result of the determination at step S30, it is determined that the provider connected to the network is not available, the determination unit extracts a list of available providers based on information obtained by the monitoring of the monitoring unit at step S60. When the determination unit selects a connection to the activated one of the available providers at step S70, the control unit establishes the connection to the activated provider.

In this case, when there is not any provider which can be selected, the process returns to step S20 until the monitoring unit can find an activated provider, and then the monitoring unit continuously performs network monitoring (not shown).

Once the selection of a network provider has completed at step S30, it is determined whether a predetermined period has elapsed since the transmission of a final push message at step S41 in order to reduce resource consumption attributable to the creation of a session between the push server and the push client. If the predetermined period has not elapsed, the process is iterated in a loop until the predetermined period has elapsed. The predetermined period may depend on the levels which are defined in Table 5 (shown below), or may be a period which is set in a linear fashion. The predetermined period may be set by a user, or may comply with a default value set by a developer. If the predetermined period is set by the user, the setting of the user takes precedence in priority over the setting of the developer.

TABLE 5

| | User | Developer | Operation |
|---|---|---|---|
| No reception | ◯ | ◯, X | no reception |
| Level 1 | ◯ | ◯, X | reception at intervals of 6 |
| | | | hours |
| Level 2 | ◯ | ◯, X | reception at intervals of 3 |
| | | | hours |
| Level 3 | ◯ | ◯, X | reception at intervals of 1 |
| | | | hour |
| Level 4 | ◯ | ◯, X | reception at intervals of |
| | | | 30 minutes |
| Level 5 | ◯ | ◯, X | reception at intervals of 5 |
| | | | minutes |

Thereafter, it is checked whether a session connection is available, that is, whether a current session exists between the push server and the push client at step S43. At a subsequent step, in order to check whether a connection to a push server is possible, if a connection has not been established or an existing session is not available, a session is created, or an existing disconnected session is deleted and then a new session is created at step S51. If the connection has been established, it is determined whether a connection to the push server is possible at step S53.

Unlike existing technology, the technology disclosed in the present application can not only determine whether a connection to a push server is possible for itself, but can also change a provider if a connection to a push server, which enables actual communication, is not possible.

That is, even when a connection to a network has been established, there are many cases where messages are not transferred. There is no technology which can check both whether a connection to a network has been established and whether actual communication is not possible and which can also change a provider when necessary. The technology disclosed in the present application checks thoroughly whether a session with a push server has been established even when a connection to a network has been established, and therefore a TCP/IP-level connection can be maintained, thereby eliminating the state in which merely a connection to a network has been established but does not work and then enabling the more accurate transfer of push messages.

Furthermore, if a connection to a push server is possible at step S53, a push message is transferred from the push server to a push client at step S80. If a connection to the network has been established but access has not been gained to the push server, a list of available providers is extracted at step S60, a connection to an activated provider is established at step S70, and then it is checked whether the connected provider is available.

The criteria for the determination of the possibility of a connection at step S53 may include one or more of a network delay attributable to a shortage of bandwidth, the impossibility of the extraction of the IP of a push server attributable to the error of a DNS, packet filtering attributable to the firewall of a network provider, the temporary impossibility of a connection during transfer over a network, and the impossibility of a connection attributable to the overload or error of a push server. If a connection is impossible, available network providers are extracted, and a new session with a new activated network provider is created when the network provider is activated.

If not only a connection to a network provider but also a connection to a push server are possible and therefore a state in which communication is fully possible is maintained, a push message is transferred from the push server to the push client at step S80. The process returns to step S20 until power is turned off at S90, and then push messages related to the application whose importance has been set are continuously transferred at S90.

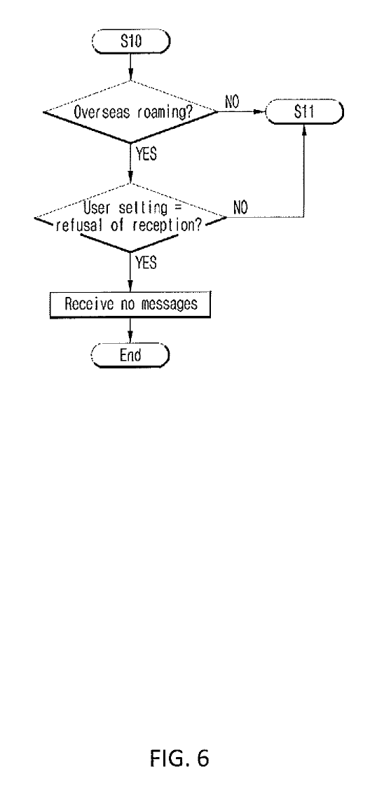

FIG. 6 is a flowchart illustrating a method of changing a provider using a push client of a mobile terminal according to another embodiment of technology disclosed in the present application. When a user arrives at an overseas destination, a mobile terminal provides an automatic roaming service. When the user arrives at the overseas destination, the mobile terminal starts to provide the automatic roaming service. If the user arrives at the overseas destination and then turns on the mobile terminal even when the user did not set the roaming service, the automatic roaming service is provided regardless of the intension of the user as soon as the user turns on the mobile terminal. In this case, even when the user does not have a watch and therefore turns on the mobile terminal just to check the time, the push data of a push application is continuously updated regardless of the intention of the user. In order to prevent such a case, it is determined whether overseas roaming has occurred.

Thereafter, if there has been no overseas roaming, this means that the user has stayed in his or her own country and, therefore, the process proceeds to step S11 of using the normal service. In contrast, if there is overseas roaming, a setting screen pops up to ask the user to refuse reception.

If the user makes setting to the refusal of reception at the above step, any type of setting including the high-level input of the user and the level setting of a developer is disregarded and messages are not allowed to be received. Furthermore, all messages are prevented from being received until a connection to a free wireless WiFi network is established. As a result, this improves the convenience for the user in an overseas roaming situation where a fee is increased in geometric progression by the simple reception of push messages.

In contrast, if the user does not make setting to the refusal of reception, the process proceeds to step S11 at which messages are normally received because the user wants to receive push messages.

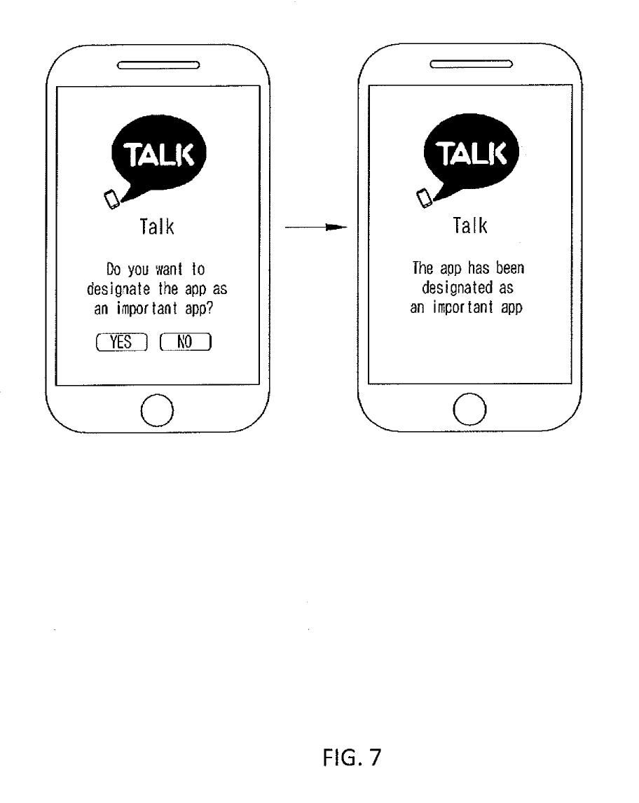

FIG. 7 shows an embodiment of a screen in which a user sets the importance, as in FIG. 4. FIG. 7 shows a screen in which input is received from a user in order to perform the method of the present application.

As shown in FIG. 7, when an application (hereinafter referred to as the “app”) is installed, information about whether the app is designated as an important app may be input by a user. Although not shown in the drawing, the setting of the user is not allowed because an X mark is indicated. For an app which is not important but is normal, the input of the user indicating that the app is not important may be received by allowing the user to select “no”.

It will be apparent that the screen and its user interface may be varied in different manners. The screen in which the setting of a user is used to perform the method disclosed in the present application may be varied.

If an app is designed as an important app, the user is prompted to select the importance. Empty stars are shown, and the importance may be selected using the number of stars. When the user presses the stars, filled stars whose number is equal to the number of pressed stars are shown, and a message, indicating that the importance corresponding to the number of filled stars has been set, may pop up.

Alternatively, the importance may be set by setting a plurality of sections among stars and selecting stars linearly, rather than by selecting the number of stars. That is, the importance corresponding to the length of sections across which a user has dragged a pointer, rather than the number of stars, may be selected. The important may be set linearly, for example, in such a way that if five star sections are presented, the total size the sections is 5 cm, a single star corresponds to six hours of level 1 and two stars correspond to three hours of level 2, a user sets 3 hours and 36 minutes by dragging a pointer over 1.2 cm.

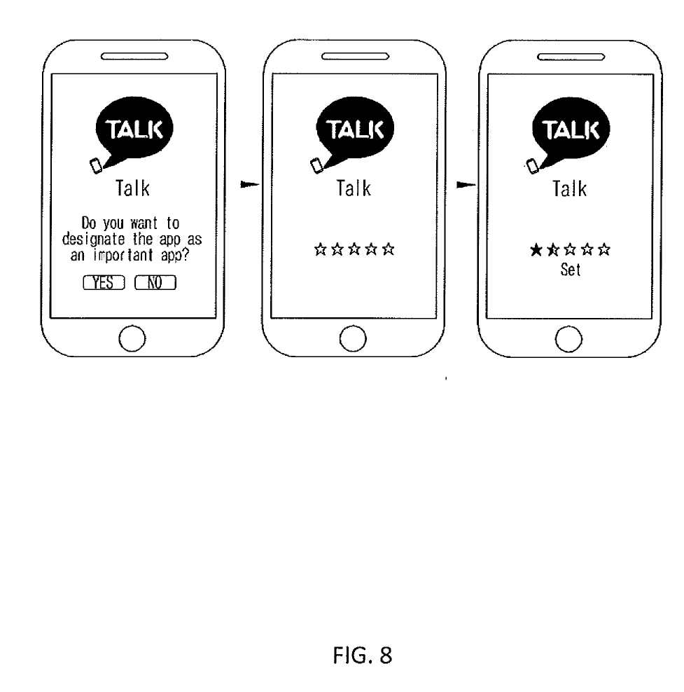

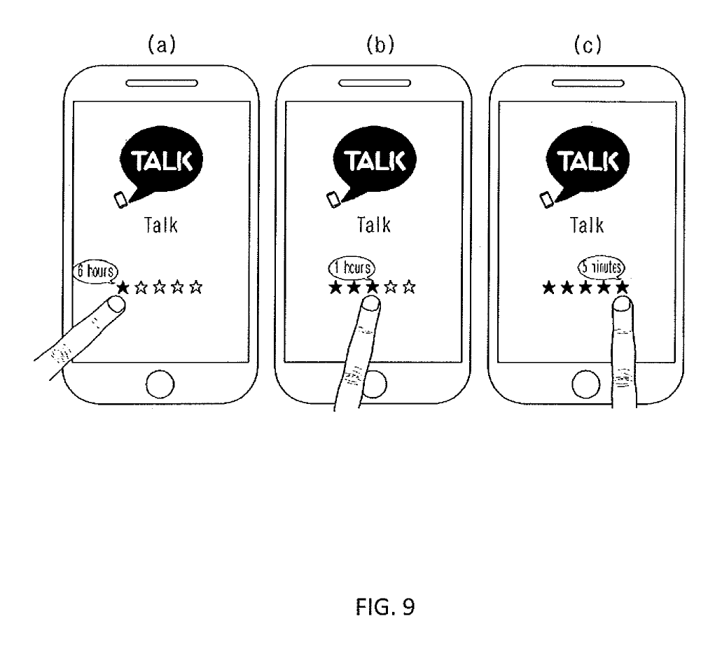

FIG. 9 shows an embodiment of a screen in which a user sets the level of importance, as in FIG. 8. This screen receives input from the user in order to perform the method of the present application which receives input related to whether setting has been made and the level of importance.

It will be apparent that the screen and its user interface may be varied in different manners. The screen in which the setting of a user is made to perform the method disclosed in the present application may be varied.

In this case, the user is prompted to select the importance. Empty stars are shown, and the importance may be selected using the number of stars. When the user presses stars, the filled stars whose number is equal to the number of pressed stars are shown, and a message, indicating that the importance corresponding to the number of filled stars has been set, may pop up.

Furthermore, as listed in Table 5, the following actions are performed based on the incremental levels: (a) when a single star is pressed, a speech bubble indicative of 6 hours pops up, thereby providing notification that unimportant messages will be reported every 6 hours to a user, (b) when 3 stars are pressed, a speech bubble indicative of 1 hour pops up, thereby providing notification that normal messages will be reported every hour to the user, and (c) when 5 stars are pressed, a speech bubble indicative of 5 minutes pops up, thereby providing notification that very important messages will be reported every 5 minutes to the user.

The above periods have been set to relatively long periods for the sake of description, but are merely illustrative. The period of level 1 may be set to 5 minutes, and the period of level 5 may be set to 10 ms. It will be apparent that the periods may be varied in different manners.

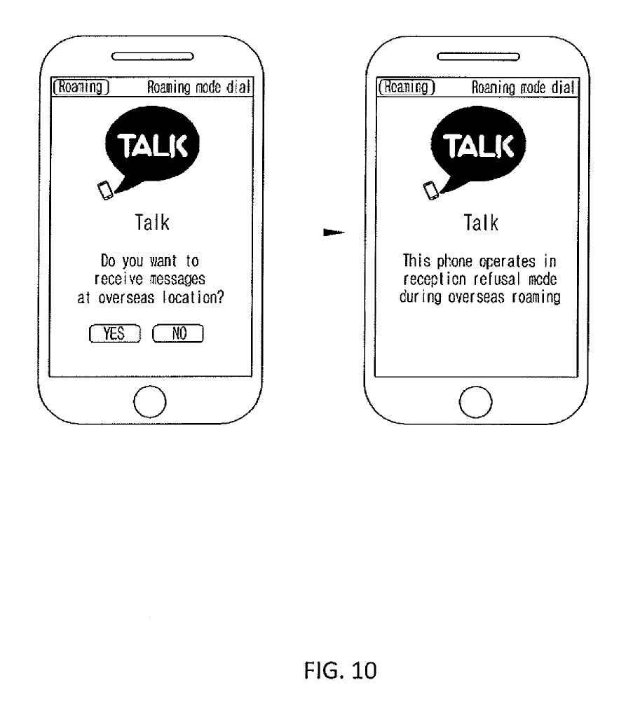

FIG. 10 shows an embodiment of a screen in which a user makes setting to the refusal of reception, as in FIG. 6. As shown in FIG. 10, a user is prompted to determine whether to receive push messages related to applications at the same time that an overseas roaming screen pops up. When push messages are received over a 3G or 4G network, a large amount of data fees may be charged. On the assumption that reception refusal operation mode has been selected, when “no” is pressed, notification is provided that a roaming service is provided in reception refusal mode.

In this reception refusal mode, reception is rejected regardless of all other settings. This state is maintained until a user connects to a free WiFi network and releases the reception refusal state. Accordingly, when a user arrives at an overseas destination and a push message is updated notwithstanding that he or she does not want to receive information about the frequent updates of apps, the problem of data fees being incurred by the simple reception of data can be prevented, a feeling of repulsion towards apps can be reduced, and a user's convenience can be increased.

In accordance with the technology disclosed in the present application, a connection to a push server is not always maintained in consideration of the limitation of a battery and the charging of fees for network resources because of the characteristics of a mobile terminal, and a push service can be provided based on the importance of the push service and network status. For this purpose, the availability of network providers and conditions for setting the actual connection to a push server are all set and detected, so that a state in which an actual connection to the push server cannot be established even when a connection to a network has been established can be eliminated, and so that active changing to a communication state where an actual service can be provided can be performed, thereby improving the quality of the reception of push messages.

As described above, the above-described present invention has the advantage of providing a push client of a mobile terminal and a method of changing a provider using the push client, which are capable of, when network status is changed because of the characteristics of a mobile terminal, actively changing a provider between WiFi, 3G and 4G providers, so that the reception of application messages is not dependent upon network status, and so that the provider can be changed such that application messages can be received even when the network status becomes poor.

Furthermore, the present invention has the advantage of providing a push client of a mobile terminal and a method of changing a provider using the push client, which are capable of actively changing the provider so that important messages can be immediately received even in a situation where a WiFi connection is dropped while a user is moving and using the WiFi service, and which are capable of checking thoroughly whether messages can be transferred by checking a session with a push server as well as the network connection, so that messages can be accurately delivered.

Furthermore, the present invention has the advantage of providing a push client of a mobile terminal and a method of changing a provider using the push client, which are capable of establishing a session with a push server while taking into consideration the power consumption required to create the session with the push server, whether a session connection is available, and whether a specific period has elapsed since the transmission of a final push message.

Furthermore, the present invention has the advantage of providing a push client of a mobile terminal and a method of changing a provider using the push client, which are capable of receiving the importance of an application from an application developer and a user, establishing a connection to the provider in conformity with the set importance, and giving priority to the importance set by the user by allowing the importance set by the user to take precedence in priority over the importance set by the developer, so that the user actively sets the reception of application messages and, therefore, the utilization of the application of the user can be maximized. Moreover, the present invention has the advantage of providing a push client of a mobile terminal and a method of changing a provider using the push client, which are capable of changing a provider in the case where a user has not set the importance of an application and a connection to a network and a session connection has not been established such that messages can be periodically received in conformity with the levels set by the application developer, and which are capable of periodically receiving messages in conformity with levels set by the user as well as an importance set by the user.

Moreover, the present invention has the advantage of providing a push client of a mobile terminal and a method of changing a provider using the push client, which are capable of, when a user has made setting to the refusal of the reception of application messages, preventing any application messages from being received regardless of the setting of an application developer, so that a feeling of repulsion towards a corresponding application can be eliminated, and so that the utilization of a mobile terminal which uses the application can become more prolific.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A push client of a mobile terminal, the push client being connected to a push server via one or more providers and including at least one application installed therein, the push client comprising:
a monitoring unit for monitoring network status of a mobile communication network, and providing data related to a determination of a possibility of receiving push messages provided by the push server; and
a control unit for, when the possibility of reception is weak, actively selecting an activated provider from among the providers based on importance of the application, thereby enabling the push messages to be received.

2. The push client of claim 1, wherein the control unit comprises a push message processing unit for, when a push message is received from the push server, transferring the push message to a corresponding application.

3. The push client of claim 1 or 2, further comprising a storage unit for, when the monitoring unit detects installation, removal or update of the application, receiving an identifier (ID) and importance of the corresponding application from the control unit, and storing them.

4. The push client of claim 1, wherein the importance of the application is any one of an importance set by a developer and an importance set by a user, and the importance set by the user takes precedence in priority over the importance set by the developer.

5. The push client of claim 4, wherein the activated provider is searched for by the monitoring unit and the control unit based on the importance setting when the importance has been set by the user or developer, basic operating mode set as default is performed without searching for the activated provider when the importance has not been set by the user or developer, and the control unit performs control so that push messages are not received when the user has made setting to refusal of the reception of push messages.

6. The push client of claim 4, wherein the importance set by the developer and the importance set by the user are set using intervals of reception of push messages, and the intervals of reception of push messages are set in incremental or linear fashion.

7. The push client of claim 6, wherein the intervals of reception of push messages are shortened in inverse proportion to the importance.

8. The push client of claim 1, wherein the possibility of reception is determined by the control unit based on at least one of a shortage of bandwidth of the provider, an error of a Domain Name Server (DNS), a firewall error, packet filtering, network connection status, and an overload and error of the push server.

9. The push client of claim 8, wherein the control unit determines the activation based on criteria including one or more of intensity of network signals, and subscription and authentication status of the user of the mobile terminal.

10. A method of changing a provider using a push client of a mobile terminal, the method comprising the steps of:
(a) when an application inside the push client is loaded, storing an ID of the application and a setting of a developer in a storage unit;
(b) when a user makes a setting, the control unit searching for an available provider; and
(c) if the available provider exists but a connection to a push server is impossible, the control unit extracting a list of other available providers and establishing a connection to an activated provider selected from among the other available providers.

11. The method of claim 10, wherein step (b) comprises, when there is no setting of the user, searching for the available provider based on the setting of the developer.

12. The method of claim 11, wherein step (c) comprises checking whether creation of a section between the push server and the push client session is necessary.

13. The method of claim 11, wherein step (c) comprises:
determining whether a predetermined period has elapsed since transmission of a final push message; and
if the predetermined period has elapsed, checking whether a session connection between the push server and the push client is available.

14. The method of claim 12 or 13, wherein step (c) further comprises:
if the creation of the session is necessary or the session connection is not available, creating the session or eliminating an existing session and creating a new session.

15. The method of claim 13, wherein the predetermined period is changed by a setting of the user or the developer.

16. The method of claim 13, wherein the setting of the user and the setting of the developer are used to set importance of the user and importance of the developer, the importance of the user and the importance of the developer are set using intervals of reception of push messages, and the intervals of reception of push messages are set in incremental or linear fashion.

17. The method of claim 16, wherein when there is no setting of the user and no setting of the developer, a connection to the push server, that is, a basic operation set as default, is not continuously monitored, and no work is performed when the connection is released.

18. The method of claim 10, wherein step (a) comprises, when overseas roaming occurs, receiving input about whether to receive push messages from the user, and terminating a process without receiving all push messages when the input is indicative of refusal of the reception of push messages.

19. The method of claim 18, wherein step (a) further comprises returning to step (b) when the input is not indicative of the refusal of the reception of push messages.
